(19) United States
(12) Patent Application Publication
(10) Pub. No.: US 2008/0078347 A1
(43) Pub. Date: Apr. 3, 2008

(54) Laser ignition device

(76) Inventors: Johann Klausner, St. Jakob i.H. (AT); Jochen Fuchs, Vienna (AT); Josef Graf, Grosspetersdorf (AT); Heinrich Kofler, Wien (AT)

Correspondence Address: WENDEROTH, LIND & PONACK, L.L.P., 2033 K STREET N. W., SUITE 800, WASHINGTON, DC, 20006-1021, US

(21) Appl. No.: 11/905,594

(22) Filed: Oct. 2, 2007

(30) Foreign Application Priority Data
Oct. 3, 2006 (AT) A 1647/2006

(51) Int. Cl. F02P 23/04

(52) U.S. Cl. 123/143 B

(57) ABSTRACT

A laser ignition arrangement for an internal combustion engine, in particular for a gas Otto engine, comprising at least one pump light source (1) and at least one laser resonator (2) which is longitudinally pumped by the pump light source (1) and in particular passively Q-switched, and in particular comprising at least one coupling-in optical means (3) for coupling pump light (4) of the pump light source (1) into the laser resonator (2), wherein preferably at a focus (6) of the coupling-in optical means (3), a first beam diameter (12) of the pump light (4) which is introduced or which is to be introduced into the laser resonator (2), measured at a pump light intensity (I_{0,6}) of 60% of the maximum pump light intensity (Iₘₐₓ), is at least 80%, preferably at least 85% of a second beam diameter (13), measured at a pump light intensity (I_{0,135}) of 13.5% of the maximum pump light intensity (Iₘₐₓ).

The present invention relates to a laser ignition device for an internal combustion engine, in particular for a gas four-stroke engine, comprising at least one pump light source and at least one laser resonator which is longitudinally pumped by the pump light source and in particular passively Q-switched, and in particular comprising at least one coupling-in optical means for coupling pump light of the pump light source into the laser resonator. In addition the invention concerns an internal combustion engine having such a laser ignition device.

Laser ignition devices of the general kind set forth are already used at least in a test mode for the ignition of internal combustion engines. The term longitudinally pumped laser resonators is used to denote in particular those types in which the pump light is coupled into the laser resonator parallel or at least approximately parallel to the direction of the laser beam produced by the laser resonator. It is known in the state of the art that, in order to obtain laser light which is as energy-rich as possible or laser pulses which are as energy-rich as possible, the individual parameters of the resonator must be perfectly matched to each other. That applies in particular in regard to the reflectivity and curvature of the decoupling mirror, the initial transmission of the absorber, the degree of doping of the laser-active medium and the geometrical dimensions of the resonator. All those are possible ways of optimising the energy output of the laser ignition device by improving the resonator.

The object of the invention is to provide a further possible way in which laser light or laser pulses which is or are as energy-rich as possible can be provided for the ignition of internal combustion engines.

In the case of laser ignition arrangements of the general kind set forth, with longitudinally pumped laser resonators, that is achieved in accordance with the invention in that, preferably at a focus of the coupling-in optical means, a first beam diameter of the pump light which is introduced or which is to be introduced into the laser resonator, measured at a pump light intensity of 60% of the maximum pump light intensity, is at least 80%, preferably at least 85% of a second beam diameter, measured at a pump light intensity of 13.5% of the maximum pump light intensity.

The invention is thus based on the realisation that the intensity distribution or beam profile of the pump light introduced into the longitudinally pumped laser resonator has a substantial influence on the attainable energies of the laser light or laser pulse which can be delivered by the laser ignition device or the laser resonator. It has been found that a homogenised beam profile—as defined by the characterising part of claim 1—is highly advantageous for pumping of the laser resonator, in the sense of a maximum energy yield. In qualitative terms, that is therefore intended to produce an intensity distribution which is as wide as possible, over the diameter of the pump light. In contrast thereto the pump light used in the state of the art generally involves an approximately Gaussian intensity distribution over the cross-section of the pump light, which signifies that the maximum intensities are concentrated on to a relatively narrow beam diameter. In that respect—as is generally usual—the intensity of the pump light is defined as the energy per time and area of the pump light and is specified using the unit [joule/(second×square meter)].

Further details and features of the invention will be described with reference to the Figures hereinafter in which:

FIG. 1 shows the components, necessary to understand the invention, of laser ignition arrangements known in the state of the art,

Fig. shows pump light profiles of laser ignition devices as shown in FIG. 1, which are known in the state of the art,

FIG. 3 to 6 show various intensity distributions according to the invention of the pump light at the focus of the coupling-in optical means in the laser resonator,

FIG. 7 shows one way of providing such a pump light intensity distribution, and

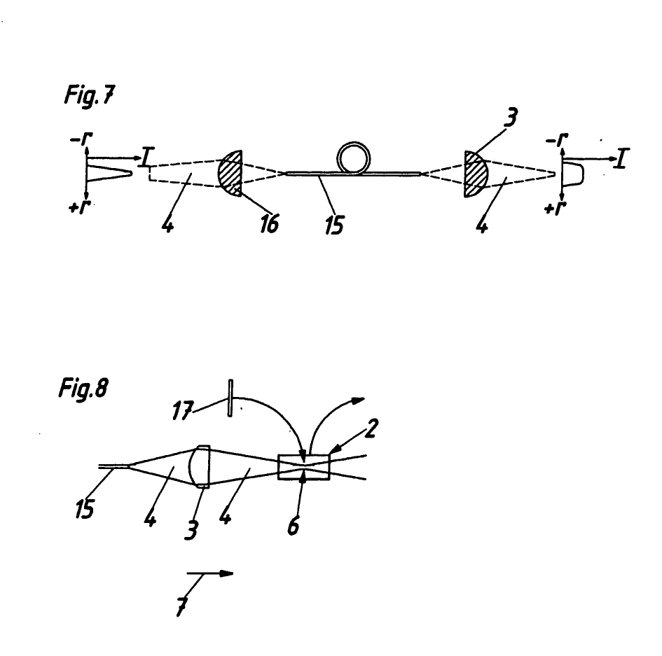

FIG. 8 shows a diagrammatic representation for measurement of the pump light intensity distribution at the focus of the coupling-in optical means.

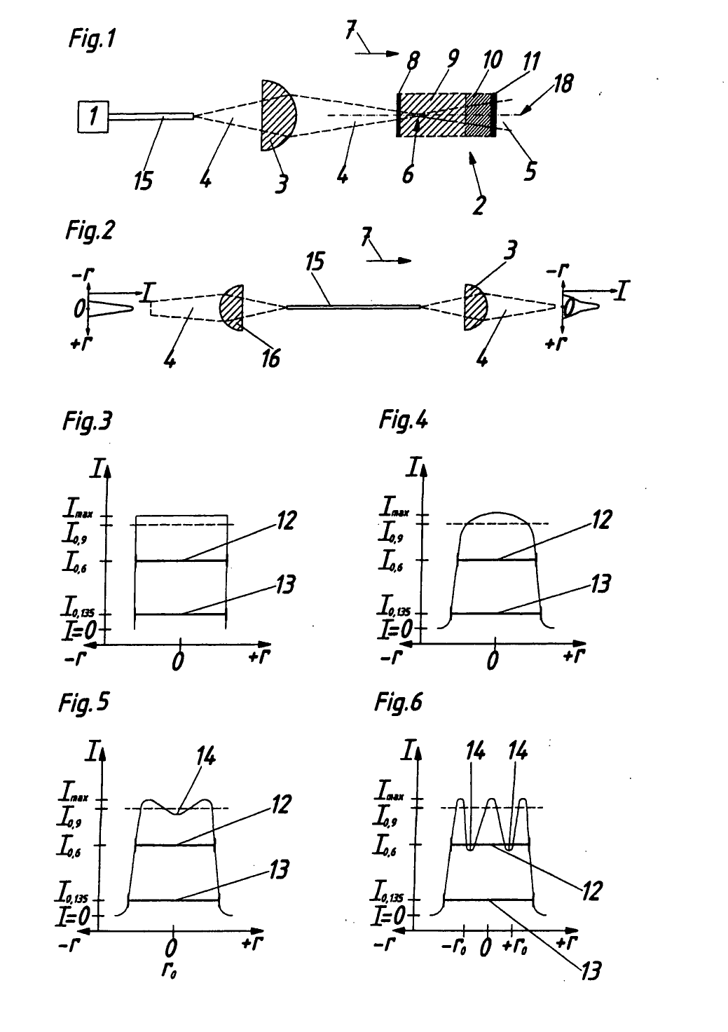

FIG. 1 firstly shows in highly diagrammatic form a layout of parts of a per se known laser ignition device of the general kind set forth. It firstly includes a pump light source 1 which for example comprises high-power laser diodes having a plurality of emitters and which feeds the pump light 4 into an optical fiber 15 by way of an optical means (shown diagrammatically as a lens 16 in FIG. 2). The coupling-in optical means 3 which is arranged between the exit of the optical fiber 15 and the laser resonator 2 (which is diagrammatically represented here by a lens) focuses the pump light 4 on to a focus 6 which is preferably in the region of the laser resonator 2 or a maximum of 50%, preferably 20%, of the length of the laser resonator 2 in front of the laser resonator 2. It is particularly preferred if the focus 6 is in the entrance mirror 8 or in the laser-active medium 9.

FIG. 1 shows a per se known, longitudinally pumped, passively Q-switched laser resonator 2. It comprises the entrance mirror 8, the laser-active medium 9, the Q-switch (passive Q-switch) 10 and the exit mirror 11. For example Nd:YAG can be used as the laser-active medium and Cr⁴⁺:YAG can be used as the Q-switch. In the longitudinally pumped laser resonators 2 of the general kind set forth, the pump light 4 which is propagated in the direction 7 is coupled into the resonator 2 substantially parallel to the light pulse or laser light 5 delivered by the resonator 2.

FIG. 2 on the left-hand side shows a distribution, which is usual in the state of the art, of the intensity I over the diameter or radius r of the pump light 4 which is produced by the pump light source 1 and fed into the optical fiber 15. Like also all other intensity distributions I shown here, the illustrated intensity distribution I is measured in a plane perpendicularly to the propagation direction 7 or the optical axis 18 of the pump light, that is to say virtually in a plan view on to the pump light. Reference “r” denotes the radial distance from the optical axis 18 arranged at r=0. In the state of the art the pump light source 1 and the transmission assembly (here consisting of the lens 16, the optical fiber 15 and the coupling-in optical means 3) are so designed that an intensity profile shown in the right-hand diagram in FIG. 2, with an approximately Gaussian intensity distribution I is produced at the focus 6 in the laser resonator 2. In the intensity distribution I in accordance with the state of the art as shown in the right-hand diagram most energy of the pump light 4 is concentrated on to a relatively narrow core region of the beam diameter.

It has now been found in accordance with the invention that the energy content of the laser light pulse or laser light 5 which is produced by the laser resonator 2 and which is to be introduced into a combustion chamber for ignition can be increased if the intensity I of the pump light 4 fed into the laser resonator 2 is homogenised, that is to say distributed more uniformly on to a wider beam diameter. In that respect it has been found that such an increase in the energy of the delivered laser light or laser pulse 5 can be achieved when, preferably at the focus 6 of the coupling-in optical means 3, a first beam diameter 12 of the pump light 4 introduced into the laser resonator 2, measured at a pump light intensity I_{0,6} of 60% of the maximum pump light intensity Iₘₐₓ, is at least 80%, preferably at least 85%, of a second beam diameter 13, measured at a pump light intensity I_{0,135} of 13.5% of the maximum pump light intensity Iₘₐₓ. Intensity distributions I over the radius r of the pump light 4, which satisfy that criterion, are shown by way of example in FIG. 3 to 6. In that respect FIG. 3 shows an idealised rectangular intensity profile. In that case the first beam diameter 12, measured at a pump light intensity I_{0,6} of 60% of the maximum pump light intensity Iₘₐₓ, is 100% of the second beam diameter 13, measured at a pump light intensity I_{0,135} of 13.5% of the maximum pump light intensity Iₘₐₓ. Such a ‘flat top’ rectangular profile which is ideal in itself cannot in practice generally be achieved. It has been found in accordance with the invention however that it is sufficient if the intensity profile of the pump light 4 is of an at least approximately rectangular configuration, as shown by way of example in FIG. 4. Here the first beam diameter 12 at the pump light intensity I_{0,6} is around 86% of the second beam diameter 13 at I_{0,135}. In that respect FIG. 4 shows a particularly preferred form of beam profiles, in which there are no relative minima in the region of the beam diameter 12, that is to say in the region of a pump light intensity greater than 60% of the maximum pump light intensity Iₘₐₓ. In that respect the reference to the relative minimum relates to its mathematical definition in respect of which it is provided that there is a relative minimum at the point r₀ whenever the intensity values I in the region around r₀ are all greater than 1 (r₀). In addition to that generally usual definition of a relative minimum, reference is made to a relative minimum in the sense of these configurations only when the deviation of the intensity value I of the relative minimum is at least 10% from the maximum pump light intensity Iₘₐₓ. A corresponding line I_{0,9} at 90% of the maximum value of the pump light intensity Iₘₐₓ is shown as a broken line in FIG. 3 to 6.

Intensity distributions of the pump light 4, in accordance with the invention, can however not only be of rectangular or approximately rectangular profiles. Rather, it is also possible to provide relative minima in the sense of the above-outlined definition in the intensity profile as shown by way of example in FIG. 5 and FIG. 6. The example of FIG. 5 shows an intensity profile in which there is a relative intensity minimum 14 at the center (r=r₀=0) or on the optical axis 18.

FIG. 6 shows by way of example an intensity distribution, with which there are two mutually separate relative minima at a spacing +/−r₀ from the center (r=0) of the pump light 4, within the first beam diameter 12. Those relative minima 14 can be separate from each other. It is however also possible that they are part of a relative minimum 14 in line form, in a plan view perpendicularly to the propagation direction 7 on to the pump light 4. It is particularly preferred in that respect if the relative minimum in line form is of a ring-shaped configuration in the above-mentioned plan view.

In general it is desirable if the pump light intensity over the total lower beam diameter 13 is at least 13.5% of the maximum pump light intensity or in particular the pump light intensity over the total upper beam diameter 12 is at least 60% of the maximum pump light intensity. The example of FIG. 6 already shows that this however is not absolutely necessary. Here, the relative minima 14 are below the I_{0,6} limit. At any event, the maximum possible width of the beam diameter is to be utilised to determine the first and second beam diameters 12 and 13 in each case, irrespective of minima which possibly occur therebetween.

The pump light 4 is mostly of rotationally symmetrical cross-sections. If that should not be the case the first beam diameter 12 and the second beam diameter 13 are to be determined in the region of their maximum extent.

FIG. 7 shows a first variant illustrating the way in which an intensity distribution of the pump light 4, in accordance with the invention (shown at the right) can be produced from the intensity distributions delivered by usual pump light sources 1 (this is shown at the left). In this variant it is proposed that the optical fiber 15 is bent to produce the desired distribution of the pump light intensity I. That gives rise to what is referred to as a ‘mode mixing’ or ‘mode scrambling’ phenomenon, which leads to the desired homogenisation of the intensity profile I at the focus 6. The required degree of bending of the optical fiber 15 can be determined by suitable tests with simultaneous measurement of the intensity distribution I produced thereby, preferably at the focus 6.

Alternatively or additionally to fiber bending, it is also possible to provide beam-guiding or beam-absorbing optical elements in the pump light transmission device or in the pump light source 1. They can be for example diffractive optical means or optical means which have a scattering effect at the center and a focusing effect at the edge. Those optical components can be designed in addition to but also integrated into the coupling-in optical means 3.

A third variant for providing the intensity distribution according to the invention provides that there is a bundle of optical fibers 15 instead of a single optical fiber 15, wherein each optical fiber 15 is then preferably associated with its own pump light source 1. By suitable matching of the intensities and the geometrical arrangement of the individual light sources 1 or fibers, a desired pump light intensity profile for coupling into the laser resonator 2 can then be produced by superpositioning of the pump light from the various optical fibers 15. It will be appreciated that it is also possible for the laser resonator 2 to be coupled directly without an interposed optical fiber bundle to a pattern of a plurality of pump light sources 1 which are appropriately matched in terms of their intensity and geometry, as is also possible in the case of individual light sources 1.

FIG. 8 shows a diagrammatic view illustrating how the intensity distribution, preferably at the focus 6, of the pump light 4 of the coupling-in optical means 3 can be measured. In that respect a so-called ‘CCD beam profiler’ 17 which is known in the state of the art can be used as the measuring device. In a first variant of the measurement procedure it is provided that the laser resonator 2 is firstly removed from the focus region 6 or measurement region in order then to measure the intensity distribution in that region by means of the beam profiler 17. That way of determining the intensity profile is based on the realisation that the light-refracting properties of the laser resonator 2 admittedly displace the focus 6 (if present) in the longitudinal direction 7, but do not substantially alter the form of the intensity distribution I, which is the important consideration here in accordance with the invention. Therefore, determining the intensity profile of the pump light 4, preferably at the focus 6, is admissible even after removal of the laser resonator 2 which is otherwise disposed there. Alternatively however it is also possible for the position of the focus 6 or the measurement region in the laser resonator 2 to be calculated having regard to the optical properties of the coupling-in optical means 3 and the laser resonator 2 and then to cut the laser resonator out of each other in the region of the focus 6 or measurement region so that then the intensity distribution I at the focus 6 or in the measurement region in the laser resonator 2 can be measured by means of the beam profiler 17. At any event that region of the beam configuration of the pump light 4 after the coupling-in optical means 3 at which the beam intensities are at the highest is to be considered as the focus. When coupling in pump light involving parallel beams, it is immaterial where the measurement region is selected in the region of the laser resonator. In the case of pump light with a divergent beam configuration, the measurement region is to be selected where the beam intensities are at the highest, in the region of the laser resonator 2. That will generally be the region of the entrance mirror 8.

1. A laser ignition device for an internal combustion engine, in particular for a gas Otto engine, comprising at least one pump light source and at least one laser resonator which is longitudinally pumped by the pump light source and in particular passively Q-switched, and in particular comprising at least one coupling-in optical means for coupling pump light of the pump light source into the laser resonator, wherein preferably at a focus (6) of the coupling-in optical means (3), a first beam diameter (12) of the pump light (4) which is introduced or which is to be introduced into the laser resonator (2), measured at a pump light intensity (I_{0,6}) of 60% of the maximum pump light intensity (Iₘₐₓ), is at least 80%, preferably at least 85% of a second beam diameter (13), measured at a pump light intensity (I_{0,135}) of 13.5% of the maximum pump light intensity (Iₘₐₓ).

2. The laser ignition device according to claim 1, wherein the laser resonator (2) has arranged in succession in the beam direction (7) of the pump light (4) an entrance mirror (8) and a laser-active medium (9) and a Q-switch (10) and an exit mirror (11).

3. The laser ignition device according to claim 2, wherein the pump light (4) can be coupled into the laser resonator (2) by way of the entrance mirror (8).

4. The laser ignition device according to claim 1, wherein the pump light intensity (1) in the region of the first beam diameter (12) does not have a relative minimum (14) with a deviation of at most 10%, preferably at most 5%, from the maximum pump light intensity (Iₘₐₓ).

5. The laser ignition device according to claim 1, wherein the pump light intensity (1) in the region of the first beam diameter (12) has a, preferably central, relative medium (14) with a deviation of at least 10% from the maximum pump light intensity (Iₘₐₓ).

6. The laser ignition device according to claim 1, wherein the pump light intensity (I) has in the region of the first beam diameter at least two and preferably a plurality of mutually separate relative minima (14) with a deviation of at least 10% in each case from the maximum pump light intensity (Iₘₐₓ).

7. The laser ignition device according to claim 1, wherein the pump light intensity (I) has at least one relative minima (14) in line form, preferably in ring form, in the region of the first beam diameter (12) in a plan view on to the cross-section of the pump light (4).

8. The laser ignition device according to claim 1, wherein the pump light intensity (I) is at least 13.5% of the maximum pump light intensity (Iₘₐₓ) over the total lower beam diameter (13).

9. The laser ignition device according to claim 1, wherein the pump light intensity (I) is at least 60% of the maximum pump light intensity (Iₘₐₓ) over the total upper beam diameter (12).

10. The laser ignition device according to claim 1, wherein a pump light transmission means for the transmission of the pump light (4) from the pump light source (1) to the coupling-in optical means (3) has at least one optical fiber (15), wherein the optical fiber (15) is bent to produce the distribution of the pump light intensity (I).

11. The laser ignition device according to claim 1, wherein a pump light transmission means for the transmission of the pump light (4) from the pump light source (1) to the coupling-in optical means (3) or the coupling-in optical means (3) itself has at least one beam-guiding and/or beam-absorbing optical element for production of the distribution of the pump light intensity (I).

12. The laser ignition device according to claim 11, wherein the beam-guiding element has a diffractive optical means or an optical means which has a scattering action at the center and a focusing action at the edge.

13. The laser ignition device as according to claim 1, wherein a pump light transmission means for the transmission of the pump light from the pump light source (1) to the coupling-in optical means (3) has a bundle of optical fibers (15) and/or the laser ignition arrangement has a plurality of pump light sources (1) for production of the distribution of the pump light intensity (I).

14. An internal combustion engine, in particular a gas Otto engine, comprising a laser ignition device according to claim 1.
